(19) United States
(12) Patent Application Publication
(10) Pub. No.: US 2024/0126525 A1
(43) Pub. Date: Apr. 18, 2024

(54) INFORMATION OUTPUT METHOD, INFORMATION OUTPUT APPARATUS, AND COMPUTER-READABLE RECORDING MEDIUM RECORDING A PROGRAM

(71) Applicant: Panasonic Intellectual Property Corporation of America, Torrance, CA (US)

(72) Inventors: Takuya YAMAGUCHI, Osaka (JP); Kenta MURAKAMI, Osaka (JP); Yuki MINODA, Hyogo (JP); Kihiro YUASA, Kanagawa (JP); Naomi TOMIYAMA, Kyoto (JP); Takamichi MATSUSAKO, Tokyo (JP); Megumi MIZOGUCHI, Kyoto (JP)

(73) Assignee: Panasonic Intellectual Property Corporation of America, Torrance, CA (US)

(21) Appl. No.: 18/394,230

(22) Filed: Dec. 22, 2023

Related U.S. Application Data
(63) Continuation of application No. PCT/JP2022/016956, filed on Mar. 31, 2022.

(30) Foreign Application Priority Data
Jun. 30, 2021 (JP) 2021-108515

(51) Int. Cl. G06F 8/61

(52) U.S. Cl. CPC G06F 8/61

(57) ABSTRACT

An information processing apparatus acquires a menu having a schedule on actions including housework; outputs information to recommend performing each of action items for a scheduled time; acquires, in automatic execution of a device or an installation, first information indicative of whether the device or the installation is in completion of preparation for the automatic execution, or second information indicative of whether the automatic execution of the device or the installation is suspended; and outputs, on the basis of the acquired first information or second information, result information indicative of an achievement level of the menu.

### TECHNICAL FIELD

The present disclosure relates to an information output method, an information output apparatus, and a computer-readable recording medium recording a program.

### BACKGROUND ART

Patent Literature 1 discloses a technique of acquiring an action amount of a user and suggesting performing an action relevant to housework to the user when an accumulation value of the action amount is less than a target value.

In Patent Literature 1, however, no consideration can be seen to create a menu having a schedule on actions including housework for a user and present the menu to the user to guide the actions of the user.

### CITATION LIST

### Patent Literature

Patent Literature 1: Japanese Unexamined Patent Publication No. 2020-17078

### SUMMARY OF INVENTION

An object of the present disclosure is to provide an information output method, an information output apparatus, and a computer-readable recording medium recording a program that can guide actions of a user on the basis of a menu and present an achievement level of the menu to the user.

An information output method according to an aspect of the present disclosure, by an information processing apparatus, includes: acquiring a menu having a schedule on actions including housework, the menu including a plurality of action items associated with respective scheduled times and a device or an installation that is associated with at least one specific action item of the action items and performs automatic execution of the specific action item; outputting information to recommend performing each of the action items for the scheduled time; acquiring, in the automatic execution of the device or the installation, first information indicative of whether the device or the installation is in completion of preparation for the automatic execution, or second information indicative of whether the automatic execution of the device or the installation is suspended; and outputting, on the basis of the acquired first information or second information, result information indicative of an achievement level of the menu.

### BRIEF DESCRIPTION OF DRAWINGS

FIG. 1 is a diagram showing a whole structure of a home control system according to an embodiment.

FIG. 2 is an illustration briefly showing a structure of a server device.

FIG. 3 is a flowchart briefly showing a flow of a process executed by an information processing part.

FIG. 4 is a flowchart showing steps of a menu creation.

FIG. 5 is an illustration showing an exemplary input screen for creating a menu.

FIG. 6 is a table briefly showing an example of time information.

FIG. 7 is a table briefly showing an exemplary menu.

FIG. 8 is a sequence diagram showing a specific menu execution.

FIG. 9 is a flowchart showing steps of a menu analysis.

FIG. 10 is a diagram showing an exemplary report.

FIG. 11 is a diagram briefly showing exemplary improvement suggestions.

FIG. 12 is a table showing a modified menu.

### DESCRIPTION OF EMBODIMENTS

### Underlying Findings for Present Disclosure

The housework is essential for a user to live; however, not a few users think that the housework is burdensome.

For the users reluctant to do the housework, doing the housework following instructions from a third person is likely to increase the efficiency of the housework in comparison with doing the housework at will.

Further, a household that has a device or an installation remote-controlled for automatic execution can be expected to improve the efficiency of the housework by effectively using the automatic execution.

To solve the above-mentioned problems, the present inventors found that the efficiency of the housework can be improved by creating a menu having a schedule on actions of the user including housework to output and present to the user information indicative of a plurality of action items for the user on the basis of the menu while controlling the automatic execution of the device or the installation, thus achieving the present disclosure.

Next, embodiments of the present disclosure will be described.

An information output method according to an aspect of the present disclosure, by an information processing apparatus, includes: acquiring a menu having a schedule on actions including housework, the menu including a plurality of action items associated with respective scheduled times and a device or an installation that is associated with at least one specific action item of the action items and performs automatic execution of the specific action item; outputting information to recommend performing each of the action items for the scheduled time; acquiring, in the automatic execution of the device or the installation, first information indicative of whether the device or the installation is in completion of preparation for the automatic execution, or second information indicative of whether the automatic execution of the device or the installation is suspended; and outputting, on the basis of the acquired first information or second information, result information indicative of an achievement level of the menu.

This configuration, in which information to recommend performing each of the action items for the scheduled time is output and the information is presented to the user, enables guiding the user to an action. Additionally, the menu has an item indicative of a device or an installation that performs automatic execution of a specific action item. The automatic execution of the device or the installation is controlled on the basis of the menu. Consequently, an improvement can be attained in the efficiency of the user action including the housework.

According to the aspect, the information processing apparatus outputs, on the scheduled time for the specific action item, command information to command the device or the installation associated with the specific action item to start the execution to the device or the installation.

This configuration enables starting the automatic execution of the device or the installation that is associated with the specific action item on the scheduled time.

According to the aspect, the information processing apparatus outputs the command information even when the device or the installation is not in the completion of the preparation for the automatic execution on the scheduled time.

This configuration, in which the automatic execution of the device or the installation is started even when the device or the installation is not in the completion of the preparation for the automatic execution, drives the user to perform an action quickly. Consequently, a further improvement can be attained in the efficiency of the user action including the housework.

According to the aspect, the information processing apparatus acquires, when the automatic execution of the device or the installation is suspended by a user after the command information is output, information indicating that the automatic execution is suspended, from the device or the installation.

This configuration, in which the information indicating that the automatic execution is suspended is acquired from the device or the installation, enables an improvement on accuracy in calculation of the achievement level of the menu.

According to the aspect, the result information includes at least one of: the number of incompletions that the device or the installation has undergone in the preparation for the automatic execution across the action items within a predetermined time; the number of events in which a user has suspended the automatic execution of the device or the installation within the predetermined time; a suggestion for provision of a new device or a new installation capable of automatic execution; a suggestion for change of an action speed level that specifies a necessary time for each of the action items; and a suggestion for increase or decrease in the number of action items on the menu.

This configuration enables providing the user with information useful to improve the efficiency of the actions including the housework.

An information output method according to an aspect of the present disclosure, by an information processing apparatus, includes: acquiring a plurality of action items including housework, creating a menu having a schedule on actions on the basis of the acquired action items, the menu including the action items, respective scheduled times associated with the action items, and a device or an installation that is associated with at least one specific action item of the action items and performs automatic execution of the specific action item; outputting information indicative of the created menu.

This configuration enables properly creating a menu in which a plurality of action items, respective scheduled times for the action items, and a device or an installation that performs automatic execution of a specific action item are associated with one another.

According to the aspect, the information processing apparatus further acquires a desired total time for the action items, and creates the menu, on the basis of the acquired action items and the desired total time, such that a total necessary time for the action items is equal to or less than the desired total time.

This configuration enables automatic creation of a proper menu along which the user can complete the action items within the desired total time.

According to the aspect, the information processing apparatus outputs, when the total necessary time exceeds the desired total time, suggestion information to suggest deletion of an action item of the action items or extension of the desired total time.

This configuration enables preventing creation of an improper menu that is impracticable for the user.

According to the aspect, the information processing apparatus calculates the total necessary time on the basis of time information concerning a setting of a necessary time for each of the action items.

This configuration, in which the time information is referred to, enables accurate calculation of the total necessary time for performing the action items.

According to the aspect, the time information includes a setting of a selectable action speed level, and the necessary time for each action item varies according to the action speed level.

This configuration enables creation of an optimum menu according to the action speed level for each user.

An information output apparatus according to an aspect of the present disclosure includes: a first acquiring part for acquiring a menu having a schedule on actions including housework, the menu including a plurality of action items associated with respective scheduled times and a device or an installation that is associated with at least one specific action item of the action items and performs automatic execution of the specific action item; a first output part for outputting information to recommend performing each of the action items for the scheduled time; a second acquiring part for acquiring, in the automatic execution of the device or the installation, first information indicative of whether the device or the installation is in completion of preparation for the automatic execution, or second information indicative of whether the automatic execution of the device or the installation is suspended; and a second output part for outputting, on the basis of the first information or second information acquired by the second acquiring part, result information indicative of an achievement level of the menu.

This configuration, in which information to recommend performing each of the action items for the scheduled time is output and the information is presented to the user, enables guiding the user to an action. Additionally, the menu has an item indicative of a device or an installation that performs automatic execution of a specific action item. The automatic execution of the device or the installation is controlled on the basis of the menu. Consequently, an improvement can be attained in the efficiency of the user action including the housework.

An information output apparatus according to an aspect of the present disclosure includes: an acquiring part for acquiring a plurality of action items including housework; a creating part for creating a menu having a schedule on actions on the basis of the action items acquired by the acquiring part, the menu including the action items, respective scheduled times associated with the action items, and a device or an installation that is associated with at least one specific action item of the action items and performs automatic execution of the specific action item; and an output part for outputting information indicative of the menu created by the creating part.

This configuration enables properly creating a menu in which a plurality of action items, respective scheduled times for the action items, and a device or an installation that performs automatic execution of a specific action item are associated with one another.

A computer-readable recording medium recording a program according to an aspect of the present disclosure causes an information processing apparatus to serve as: first acquiring means for acquiring a menu having a schedule on actions including housework, the menu including a plurality of action items associated with respective scheduled times and a device or an installation that is associated with at least one specific action item of the action items and performs automatic execution of the specific action item; first output means for outputting information to recommend performing each of the action items for the scheduled time; second acquiring means for acquiring, in the automatic execution of the device or the installation, first information indicative of whether the device or the installation is in completion of preparation for the automatic execution, or second information indicative of whether the automatic execution of the device or the installation is suspended; and second output means for outputting, on the basis of the first information or second information acquired by the second acquiring means, result information indicative of an achievement level of the menu.

This configuration, in which information to recommend performing each of the action items for the scheduled time is output and the information is presented to the user, enables guiding the user to an action. Additionally, the menu has an item indicative of a device or an installation that performs automatic execution of a specific action item. The automatic execution of the device or the installation is controlled on the basis of the menu. Consequently, an improvement can be attained in the efficiency of the user action including the housework.

A computer-readable recording medium recording a program according to an aspect of the present disclosure causes an information processing apparatus to serve as: acquiring means for acquiring a plurality of action items including housework; creating means for creating a menu having a schedule on actions on the basis of the acquired action items acquired by the acquiring means, the menu including the action items, respective scheduled times associated with the action items, and a device or an installation that is associated with at least one specific action item of the action items and performs automatic execution of the specific action item; and output means for outputting information indicative of the menu created by the creating means.

This configuration enables properly creating a menu in which a plurality of action items, respective scheduled times for the action items, and a device or an installation that performs automatic execution of a specific action item are associated with one another.

This disclosure can be realized as: a program for causing a computer to execute each distinctive feature included in such a method or an apparatus; or a system operated by the program. Additionally, it goes without saying that the program is distributable as a non-transitory computer readable storage medium like a CD-ROM, or distributable via a communication network like the Internet.

### Embodiments of Present Disclosure

Embodiments of the present disclosure will be described below with reference to the drawings. The elements given the same reference numerals in different drawings are defined to be the same or like elements. Constituent elements, dispositions thereof, connections between them, and the order of operations described below are mere examples, and thus should not be construed to delimit the disclosure. Only the claims delimit the present disclosure. Hence, constituent elements which are not recited in the independent claims each showing the broadest concept among the constituent elements in the embodiments are described as being ones not necessarily required to accomplish the object of the present disclosure but required to achieve preferable configurations.

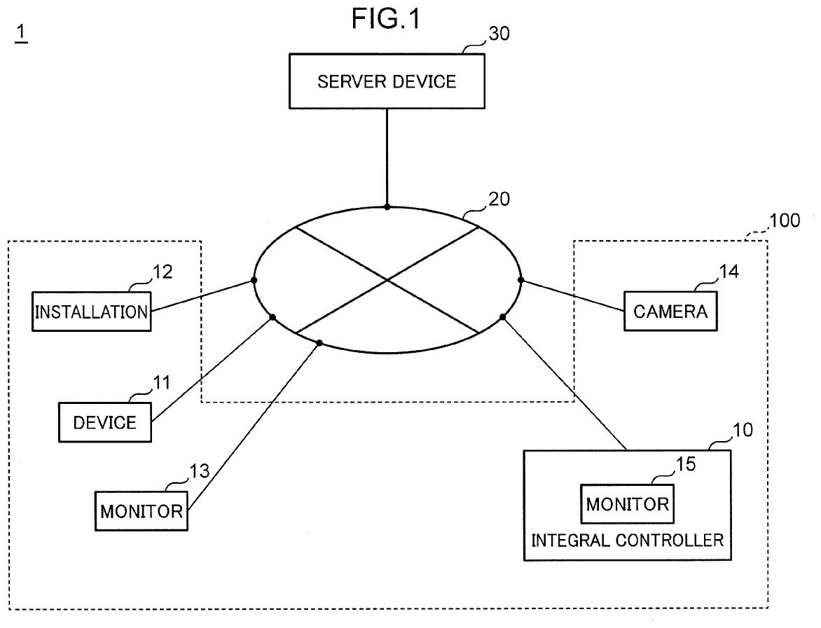

FIG. 1 is a diagram showing a whole structure of a home control system 1 according to an embodiment of the present disclosure. The home control system 1 includes a smart home 100, a communication network 20, and a server device 30. Only one smart home 100 is shown in FIG. 1 for a brief explanation, but a plurality of smart homes 100 may be included. The present disclosure can be applied to a house such as a smart home 100, and to an indoor facility, e.g., an office, a restaurant, a commercial facility, but is not limited to the indoor facility and can be applied to a space having both an indoor space and an outdoor space.

The smart home 100 has a plurality of spaces (e.g., a room, a bathroom, a toilet, an entrance, a corridor) in which a plurality of devices 11 and a plurality of installations 12 are disposed. The devices 11 include an electronic device, e.g., a home appliance. The devices 11 are IoT devices, e.g., a washing machine, an air conditioner, a TV, a refrigerator, a rice cooker, a microwave oven, and a lamp. The installations 12 include an appliance used in a place and fixed thereto or furniture.

In the smart home 100, a plurality of monitors 13 and a plurality of cameras 14 are disposed. The monitor 13 is an LCD or an organic EL display. The monitor 13 is disposed in the vicinity of the device 11 or the installation 12 with which a user does the housework. The camera 14 captures a state where the user living in the smart home 100 does the housework.

The smart home 100 includes an integral controller 10 for remotely controlling a device 11 and an installation 12 that are the control target among the devices 11 and the installations 12. The integral controller 10 can perform mutual data communication with a device 11 and an installation 12 that are the control target through a communication network 20 such as a public network (or a wireless LAN). The integral controller 10 has a monitor 15 such as an LCD or an organic EL display. The integral controller 10 can accept data input by the user through a touchscreen monitor 15 or by a button. Information presentation to the user and data input by the user may be performed through a communication terminal of the user such as a smartphone, after registration of the communication terminal.

The server device 30 is a cloud server or an edge server and manages the whole home control system 1. The server device 30 can perform mutual data communication with the integral controller 10, the devices 11, the installations 12, the monitors 13, and the cameras 14 through the communication network 20. The functions of the server device 30 may be included in the integral controller 10.

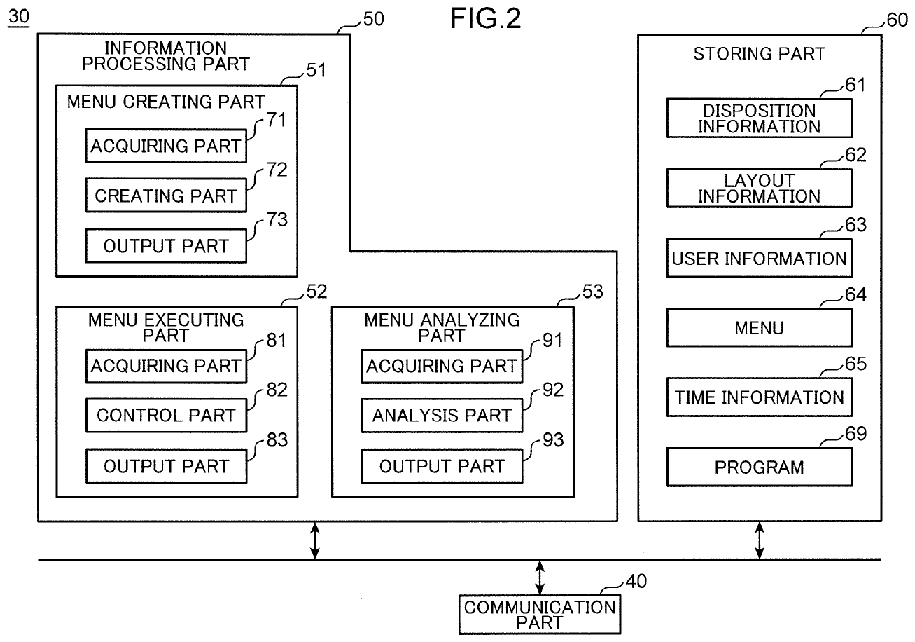

FIG. 2 is an illustration briefly showing a structure of the server device 30. The server device 30 includes a communication part 40, an information processing part 50, and a storing part 60.

The communication part 40 includes a communication module compatible with a communication system such as an IP.

The storing part 60 includes, for example, an HDD, an SSD, or a flash memory. The storing part 60 stores disposition information 61, layout information 62, user information 63, a menu 64, time information 65, and a program 69. The disposition information 61 indicates where in the smart home 100 the devices 11, the installations 12, the monitors 13, the cameras 14, and the integral controller 10 are disposed. The layout information 62 indicates the layout of the spaces (e.g., a room, a corridor) of the smart home 100. The user information 63 indicates a user living in the smart home 100. In a case that a plurality of users lives in the smart home 100, respective user IDs that enable identification of the users are given. The menu 64 serves as information on a schedule on actions of the user including housework, which will be described later. The time information 65 concerns a setting of a necessary time for each of the action items on the menu 64, which will be described later.

The information processing part 50 includes a menu creating part 51, a menu executing part 52, and a menu analyzing part 53, which are established by causing a CPU to execute the program 69 read in a ROM or a RAM from the storing part 60. The menu creating part 51 includes an acquiring part 71, a creating part 72, and an output part 73. The menu executing part 52 includes an acquiring part 81, a control part 82, and an output part 83. The menu analyzing part 53 includes an acquiring part 91, an analysis part 92, and an output part 93. In other words, the program 69 causes the information processing part 50 provided in the server device 30 serving as the information output apparatus to serve as these processing parts.

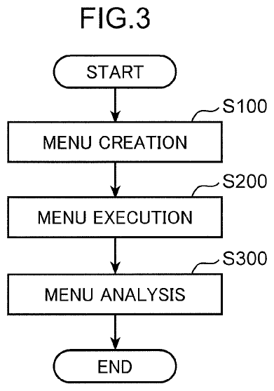

FIG. 3 is a flowchart briefly showing a flow of a process executed by the information processing part 50. First, in Step S100, the menu creating part 51 creates a menu 64 and stores the created menu 64 in the storing part 60. Next, in Step S200, the menu executing part 52 reads the menu 64 from the storing part 60 to execute it. Next, in Step S300, the menu analyzing part 53 analyzes the result of the execution of the menu 64. The process in each step will be described later.

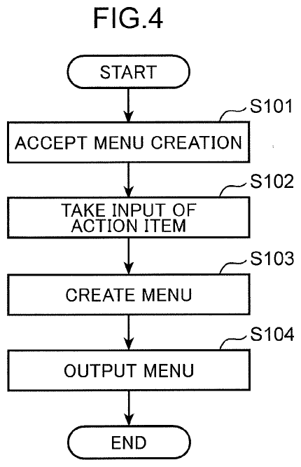

FIG. 4 is a flowchart showing steps of a menu creation (in Step S100) shown in FIG. 3. In the case described below, the information presentation to the user and the data input by the user are performed through the integral controller 10, but may be performed through a communication terminal such as a smartphone as described above.

When the user inputs a command of menu creation through the integral controller 10, the communication part 40 of the server device 30 receives the command from the integral controller 10 through the communication network 20. In Step S101, the acquiring part 71 acquires the command from the communication part 40 and accepts instructions for creating the menu.

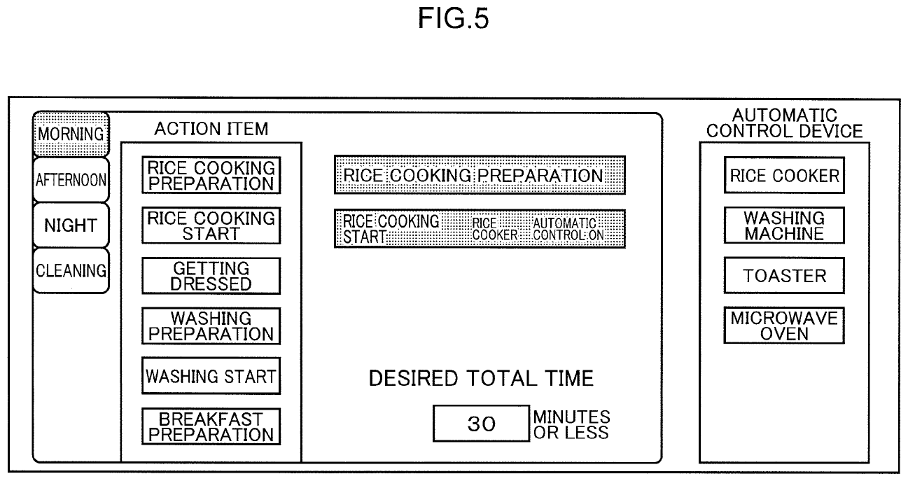

FIG. 5 is an illustration showing an exemplary input screen for creating a menu displayed on the monitor 15 of the integral controller 10. When the user selects a classification among, e.g., “MORNING”, “AFTERNOON”, and “NIGHT” displayed on the left side of the input screen, a plurality of action items corresponding to the selected classification is automatically displayed. In the example shown in FIG. 5, the classification of “MORNING” is selected. An action item is information indicative of a representative or typical action of a user corresponding to a selected classification. Action items predetermined according to each classification are listed on the monitor 15. Other action items beyond the screen can be displayed on the screen by user's scrolling.

The user selects at least one action item to perform by tapping from the listed action items. The selected action item is extracted to be displayed on the right side of the list of the action items. In the example shown in FIG. 5, “RICE COOKING PREPARATION” and “RICE COOKING START” are selected.

An automatic control device relevant to the listed action items is displayed on the right side of the input screen. The automatic control device, which is among the devices 11, is capable of performing automatic execution of an action item by remote control. In the example shown in FIG. 5, “RICE COOKER”, “WASHING MACHINE”, “TOASTER”, and “MICROWAVE OVEN” are listed as the automatic control device. An automatic control installation may be displayed in addition to the automatic control device. The automatic control installation, which is among the installations 12, is capable of performing automatic execution of an action item by remote control.

In a case that the selected action items include an action item (hereinafter, referred to as “specific action item”) of which automatic execution can be performed by a device 11 or an installation 12 and the user desires the automatic execution, the user selects the automatic control device corresponding to the specific action item by drag-and-drop. The specific action item and the automatic control device are thereby associated with each other. In the example shown in FIG. 5, the specific action item of “RICE COOKING START” and the automatic control device of “RICE COOKER” are associated with each other.

The input screen has an input box to which a maximum necessary time (desired total time) from the start to the completion of performing the selected action items is input. In the example shown in FIG. 5, the desired total time is set at “WITHIN 30 MINUTES”.

The input data by the user (e.g., selected action items, automatic control device, desired total time) is transmitted from the integral controller 10 to the server device 30 through the communication network 20, and received by the communication part 40 of the server device 30.

With reference to FIG. 4, next, in Step S102, the acquiring part 71 acquires the input data from the communication part 40 and takes input of, e.g., an action item included in the input data.

Next, in Step S103, the creating part 72 creates a menu 64 on the basis of the input data acquired in Step 102 and time information 65 read from the storing part 60.

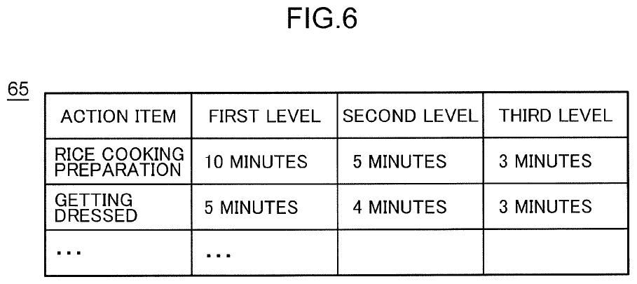

FIG. 6 is a table briefly showing an example of time information 65. The time information 65 is table information concerning a setting of a necessary time for each of the action items. The time information 65 includes a setting of a selectable action speed level for each user, and the necessary time for each action item is set to a value, which varies according to the action speed level. In the example shown in FIG. 6, an action speed level is set to have three stages (first level, second level, and third level); for example, with respect to the action item of “RICE COOKING PREPARATION”, the respective necessary times are set to “10 MINUTES” at the first level, “5 MINUTES” at the second level, and “3 MINUTES” at the third level. A value for an action speed level is initially set to be one at the first level for each user, and is changed to be ones at the second level and at the third level one after another in proportion to the achievement.

According to the action speed level set for a user, the creating part 72 specifies the respective necessary times for the action items included in the input data from the time information 65. The creating part 72 creates the menu 64 such that a calculated total necessary time is equal to or less than the desired total time, by rearranging the order of the action items and parallelizing action items that can be performed simultaneously so as to achieve the maximum efficiency, i.e., minimize the total necessary time.

When the calculated total necessary time exceeds the desired total time, the creating part 72 creates suggestion information to suggest deletion of an action item of the action items included in the input data. The suggestion information may include information to specify an action item to be deleted according to the excessive time. Alternatively, when the calculated total necessary time exceeds the desired total time, the creating part 72 creates suggestion information to suggest extension of the desired total time. The suggestion information may include information indicative of required extension time corresponding to the excessive time. The suggestion information created by the creating part 72 is output from the output part 73 and transmitted to the integral controller 10 through the communication part 40 and the communication network 20. The integral controller 10 displays a suggestion represented by the received suggestion information on the monitor 15, so as to present the suggestion to the user. The creating part 72 creates the menu 64 on the basis of the response (including deletion of an action item or extension of the desired total time) by the user to the suggestion information.

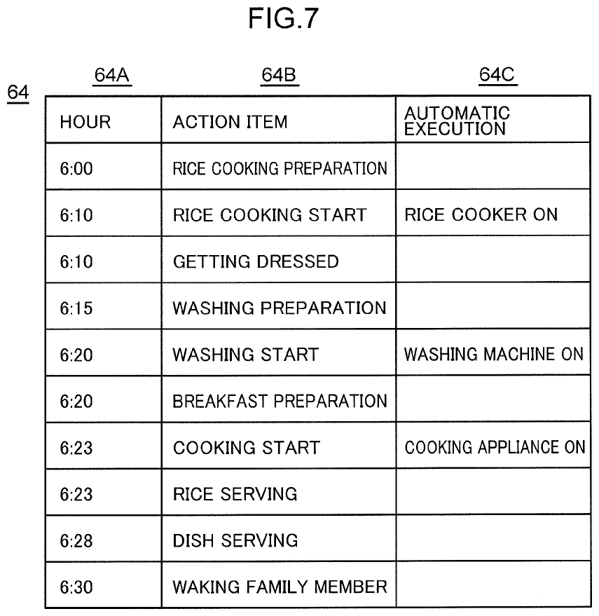

FIG. 7 is a table briefly showing an exemplary menu 64. The menu 64 has a first column 64A indicative of respective scheduled times for the action items, a second column 64B indicative of the action items associated with the respective scheduled times, and a third column 64C indicative of a device 11 or an installation 12 that is associated with at least one specific action item of the action items and performs automatic execution of the specific action item; and shows, for example, that the washing is started at 6:20 with the start of the automatic execution of the washing machine.

The menu 64 created by the creating part 72 is output from the output part 73 and stored in the storing part 60.

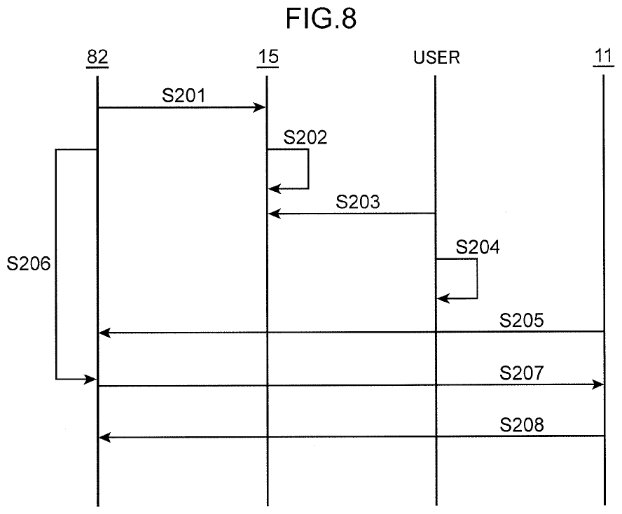

FIG. 8 is a sequence diagram showing a specific menu execution (in Step S200) shown in FIG. 3. In FIG. 8, steps of a process will be described focusing only on the action items of “WASHING PREPARATION” and “WASHING START” on the menu 64 shown in FIG. 7 for simplification.

The acquiring part 81 acquires the menu 64 by reading the menu 64 from the storing part 60.

On the scheduled time (6:15) for the action item of “WASHING PREPARATION”, the control part 82 creates guidance information including guidance to recommend the user to start washing preparation. The guidance information created by the control part 82 is output from the output part 83 and transmitted to the integral controller 10 through the communication part 40 and the communication network 20 (Step S201). The integral controller 10 displays a guidance represented by the received guidance information on the monitor 15, so as to present the guidance to the user (Step S202). The guidance may be displayed on a monitor 13 disposed in a space where the user is present or on the smartphone of the user, instead of on the monitor 15 of the integral controller 10. The space where the user is present can be identified by the information processing part 50 analyzing the images captured by the camera 14 in real time. The presentation of the guidance to the user is not limited to by way of display on the monitor 15, and may be by way of sound output from a speaker.

The user visually checks the guidance displayed on the monitor 15 (Step S203). The user thereafter prepares for the washing (Step S204). Specifically, the user opens a lid of the washing machine, puts the laundry into the washing tub, and closes the lid of the washing machine. The washing machine detects by way of an opening/closing sensor that the lid is opened and closed, and detects by way of a weight sensor that the laundry is put thereinto. The result of the detections of the opening/closing sensor and the weight sensor, which serves as log information indicative of an operational record, is transmitted from the washing machine to the server device 30 through the communication network 20; the log information is input to the control part 82 (Step S205). The log information corresponds to first information indicative of whether the device 11 or the installation 12 is in completion of preparation for the automatic execution at the time of the automatic execution.

The control part 82 stands by for the scheduled time (6:20) for the action item of “WASHING START” following “WASHING PREPARATION” (Step S206). The control part 82 creates, on the scheduled time, command information to command the start of the execution of the washing. The command information created by the control part 82 is output from the output part 83 and transmitted to the washing machine through the communication part 40 and the communication network 20 (Step S207). The washing machine starts the automatic execution of the washing according to the received command information.

The control part 82 creates and outputs the command information on the scheduled time even if the log information in Step S205 is not input. Thus, the automatic execution of the washing of the washing machine is started even when the washing preparation is not completed.

In a case that the user suspends the automatic execution after the start of the automatic execution of the washing machine due to, e.g., incompletion of the washing preparation, the washing machine outputs suspension information indicating that the automatic execution is suspended by the user. The suspension information corresponds to second information indicative of whether the automatic execution of the device 11 or the installation 12 is suspended. The suspension information is transmitted from the washing machine to the server device 30 through the communication network 20 and input to the control part 82 (Step S208).

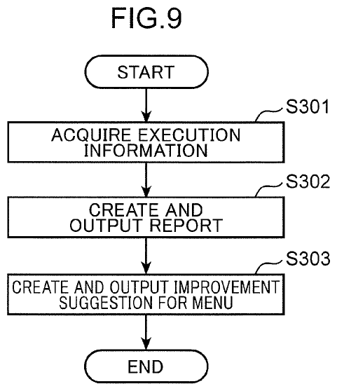

FIG. 9 is a flowchart showing steps of a menu analysis (in Step S300) shown in FIG. 3.

First, in Step S301, the acquiring part 91 acquires execution information on the device 11 or the installation 12 subjected to the automatic execution from the control part 82. The execution information includes the first information (log information) and the second information (suspension information) described above.

Next, in Step S302, the analysis part 92 creates a report serving as result information indicative of an achievement level of the menu 64 after an analysis on an accumulation of the execution information within a predetermined time (e.g., a week).

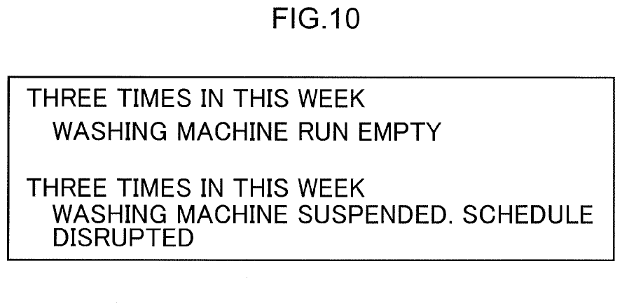

FIG. 10 is a diagram showing an exemplary report. The exemplary report, which is for the washing machine, includes the number of incompletions in the preparation for the automatic execution before the start thereof and the number of events in which the user has suspended the automatic execution after the start thereof. The report created by the analysis part 92 is output from the output part 93 and transmitted to the integral controller 10 through the communication part 40 and the communication network 20. The integral controller 10 displays the received report on the monitor 15, so as to present the result information to the user. The report may be displayed on the smartphone of the user, instead of on the monitor 15 of the integral controller 10.

Next, in Step S303, the analysis part 92 creates an improvement suggestion for the menu 64 on the basis of the result of the analysis in Step S302. In a case that the achievement level of the menu 64 within the latest predetermined time is high, e.g., in a case that a rate of the incompletions in the preparation for the automatic execution before the start thereof is less than a predetermined threshold, the analysis part 92 suggests, e.g., raising the action speed level shown in FIG. 6 or increasing the number of the action items included in the menu 64.

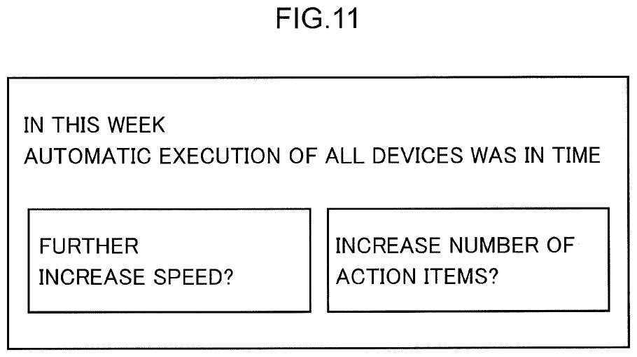

FIG. 11 is a diagram briefly showing exemplary improvement suggestions. This example includes improvement suggestions including both raising the action speed level and increasing the number of the action items.

In a case that the achievement level of the menu 64 within the latest predetermined time is low, e.g., in a case that the rate of the incompletions in the preparation for the automatic execution before the start thereof is not less than the predetermined threshold, the analysis part 92 suggests, e.g., reducing the action speed level shown in FIG. 6 or decreasing the number of the action items included in the menu 64. In the case that the achievement level of the menu 64 is low, the analysis part 92 may suggest purchase of a new device 11 or a new installation 12 capable of automatic execution. For example, the analysis part 92 suggests provision of an autonomous cleaning robot to a household that does not have such a cleaning robot. Alternatively, the analysis part 92 suggests replacement of a cooking device without a specific function that can be automatically executed with a cooking device with the specific function.

The improvement suggestion created by the analysis part 92 is output from the output part 93 and transmitted to the integral controller 10 through the communication part 40 and the communication network 20. The integral controller 10 displays the received improvement suggestion on the monitor 15, so as to present it to the user. The improvement suggestion may be displayed on the smartphone of the user, instead of on the monitor 15 of the integral controller 10. When the server device 30 receives response information including acceptance of the improvement suggestion, the creating part 72 creates a new menu 64 reflecting the improvement suggestion and stores the new menu 64 in the storing part 60.

In the embodiment, guidance information to recommend performing each of the action items for the scheduled time is output and presented to the user, which enables guiding the user to an action. Additionally, the menu 64 has an item indicative of a device 11 or an installation 12 that performs automatic execution of a specific action item. The automatic execution of the device 11 or the installation 12 is controlled on the basis of the menu 64. Consequently, an improvement can be attained in the efficiency of the user action including the housework.

### Modifications

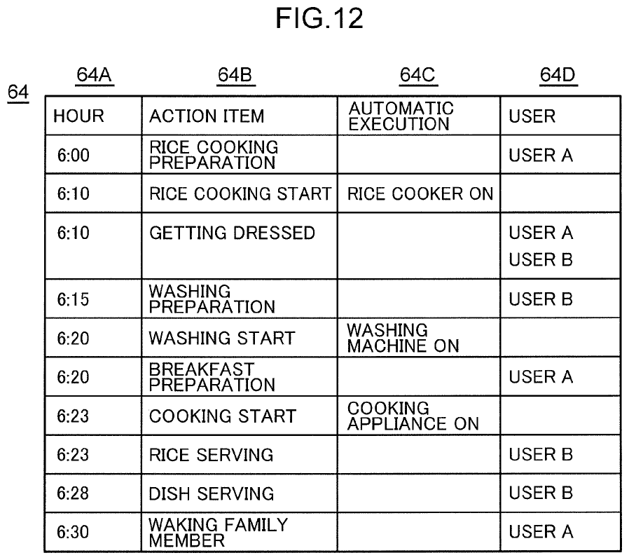

FIG. 12 is a diagram showing a modified menu 64. The menu 64 may have a fourth column 64D indicative of respective users performing the action items in addition to the first column 64A to the third column 64C shown in FIG. 7. In this case, the guidance information may be transmitted by user, and the result information and the improvement suggestion may be created by user. The transmission of information by user may be achieved through a communication terminal of each user.

The scheduled time shown in the first column 64A of the menu 64 is the hour, or may be the elapsed time since a specific time.

In the input screen shown in FIG. 5, there may be no classification of “MORNING”, “AFTERNOON”, and “NIGHT”. In this case, all of the action items may be listed regardless of the classification by time zone.

In the input screen shown in FIG. 5, the automatic control device that is associated with the certain action item may be input automatically instead of by a user.

In the input screen shown in FIG. 5, there may be provided presets in each of which certain action items are associated with a time zone, e.g., “MORNING”, “AFTERNOON”, and “NIGHT”; and a preset associated with a selected classification may be input automatically.

In the input screen shown in FIG. 5, there may be prepared a preset for each kind of the housework, e.g., cleaning, washing, cooking, in addition to the presets for the time zones.

In the input screen shown in FIG. 5, input of specifying information to specify the order of the action items may be accepted.

In the input screen shown in FIG. 5, input of target difficulty instead of the desired total time may be accepted. In this case, when a high target difficulty is input, the second level shown in FIG. 6 may be selected; and when a low target difficulty is input, the first level shown in FIG. 6 may be selected.

Each necessary time set in the time information 65 shown in FIG. 6 may be changeable by the user.

The menu creating part 51 may create a new menu 64 by referring to record information on the menu creation within a predetermined time in the past. For example, the menu creating part 51 may add to the menu 64, e.g., the action item that has been frequently used or the action item that has been frequently added manually by the user. The menu creating part 51 may create a menu 64 including, as available automatic execution, a function of a device 11 of which use frequency for the past menu is less than a predetermined value or a function of which use frequency in the past operation of the device 11 is less than a predetermined value. The menu creating part 51 may create a menu 64 including a function of which use frequency is low for the user but high for another user as available automatic execution.

In the case that the washing machine is subjected to the automatic execution, the contents of the menu 64 may be changed according to the laundry. For example, in a case that the user is detected to wear fancy clothes by analyzing the images captured by the camera 14, a menu 64 including a washing program for fancy clothes may be used the day thereafter. The washing program for fancy clothes requires a time for washing preparation longer than that for the normal washing program. Purchase of fancy clothes may be suggested to a user for which the number of fancy clothes in possession is less than a predetermined value. Increase in frequency of wearing fancy clothes may be suggested to a user for which the rate of wearing fancy clothes is less than a predetermined value.

### INDUSTRIAL APPLICABILITY

The present disclosure is useful especially when applied to a home control system for use in a smart home with IoT technology.

1. An information output method, by an information processing apparatus, comprising:
acquiring a menu having a schedule on actions including housework, the menu including a plurality of action items associated with respective scheduled times and a device or an installation that is associated with at least one specific action item of the action items and performs automatic execution of the specific action item;
outputting information to recommend performing each of the action items for the scheduled time;
acquiring, in the automatic execution of the device or the installation, first information indicative of whether the device or the installation is in completion of preparation for the automatic execution, or second information indicative of whether the automatic execution of the device or the installation is suspended; and
outputting, on the basis of the acquired first information or second information, result information indicative of an achievement level of the menu.

2. The information output method according to claim 1, wherein
the information processing apparatus outputs, on the scheduled time for the specific action item, command information to command the device or the installation associated with the specific action item to start the execution to the device or the installation.

3. The information output method according to claim 2, wherein
the information processing apparatus outputs the command information even when the device or the installation is not in the completion of the preparation for the automatic execution on the scheduled time.

4. The information output method according to claim 3, wherein
the information processing apparatus acquires, when the automatic execution of the device or the installation is suspended by a user after the command information is output, information indicating that the automatic execution is suspended, from the device or the installation.

5. The information output method according to claim 1, wherein
the result information includes at least one of:
the number of incompletions that the device or the installation has undergone in the preparation for the automatic execution across the action items within a predetermined time;
the number of events in which a user has suspended the automatic execution of the device or the installation within the predetermined time;
a suggestion for provision of a new device or a new installation capable of automatic execution;
a suggestion for change of an action speed level that specifies a necessary time for each of the action items; and
a suggestion for increase or decrease in the number of action items on the menu.

6. An information output method, by an information processing apparatus, comprising:
acquiring a plurality of action items including housework,
creating a menu having a schedule on actions on the basis of the acquired action items, the menu including the action items, respective scheduled times associated with the action items, and a device or an installation that is associated with at least one specific action item of the action items and performs automatic execution of the specific action item;
outputting information indicative of the created menu.

7. The information output method according to claim 6, wherein
the information processing apparatus further acquires a desired total time for the action items, and
creates the menu, on the basis of the acquired action items and the desired total time, such that a total necessary time for the action items is equal to or less than the desired total time.

8. The information output method according to claim 7, wherein
the information processing apparatus outputs, when the total necessary time exceeds the desired total time, suggestion information to suggest deletion of an action item of the action items or extension of the desired total time.

9. The information output method according to claim 7, wherein
the information processing apparatus calculates the total necessary time on the basis of time information concerning a setting of a necessary time for each of the action items.

10. The information output method according to claim 9, wherein
the time information includes a setting of a selectable action speed level, and
the necessary time for each action item varies according to the action speed level.

11. An information output apparatus comprising:
a first acquiring part for acquiring a menu having a schedule on actions including housework, the menu including a plurality of action items associated with respective scheduled times and a device or an installation that is associated with at least one specific action item of the action items and performs automatic execution of the specific action item;
a first output part for outputting information to recommend performing each of the action items for the scheduled time;
a second acquiring part for acquiring, in the automatic execution of the device or the installation, first information indicative of whether the device or the installation is in completion of preparation for the automatic execution, or second information indicative of whether the automatic execution of the device or the installation is suspended; and
a second output part for outputting, on the basis of the first information or second information acquired by the second acquiring part, result information indicative of an achievement level of the menu.

12. An information output apparatus comprising:
an acquiring part for acquiring a plurality of action items including housework;
a creating part for creating a menu having a schedule on actions on the basis of the action items acquired by the acquiring part, the menu including the action items, respective scheduled times associated with the action items, and a device or an installation that is associated with at least one specific action item of the action items and performs automatic execution of the specific action item;
an output part for outputting information indicative of the menu created by the creating part.

13. A computer-readable recording medium recording a program causing an information processing apparatus to serve as:
first acquiring means for acquiring a menu having a schedule on actions including housework, the menu including a plurality of action items associated with respective scheduled times and a device or an installation that is associated with at least one specific action item of the action items and performs automatic execution of the specific action item;
first output means for outputting information to recommend performing each of the action items for the scheduled time;
second acquiring means for acquiring, in the automatic execution of the device or the installation, first information indicative of whether the device or the installation is in completion of preparation for the automatic execution, or second information indicative of whether the automatic execution of the device or the installation is suspended; and
second output means for outputting, on the basis of the first information or second information acquired by the second acquiring means, result information indicative of an achievement level of the menu.

14. A computer-readable recording medium recording a program causing an information processing apparatus to serve as:
acquiring means for acquiring a plurality of action items including housework;
creating means for creating a menu having a schedule on actions on the basis of the acquired action items acquired by the acquiring means, the menu including the action items, respective scheduled times associated with the action items, and a device or an installation that is associated with at least one specific action item of the action items and performs automatic execution of the specific action item; and
outputting means for outputting information indicative of the menu created by the creating means.
